(19) United States
(12) Patent Application Publication
(10) Pub. No.: US 2007/0104148 A1
(43) Pub. Date: May 10, 2007

(54) Apparatus and method of processing handover of a mobile relay station in broadband wireless access (BWA) communication system using multihop relay scheme

(75) Inventors: Hyun-Jeong Kang, Seoul (KR); Pan-Yuh Joo, Seoul (KR); Jung-Je Son, Seongnam-si (KR); Jae-Weon Cho, Suwon-si (KR); Hyoung-Kyu Lim, Seoul (KR); Yeong-Moon Son, Anyang-si (KR); Sung-Jin Lee, Seoul (KR); Mi-Hyun Lee, Seoul (KR); Song-Nam Hong, Seoul (KR); Young-Ho Kim, Suwon-si (KR)

Correspondence Address: DILWORTH & BARRESE, LLP, 333 EARLE OVINGTON BLVD., SUITE 702, UNIONDALE, NY, 11553, US

(73) Assignee: Samsung Electronics Co., Ltd., Suwon-si (JP)

(21) Appl. No.: 11/594,363

(22) Filed: Nov. 7, 2006

(30) Foreign Application Priority Data
Nov. 7, 2005 (KR) 2005-0105808

(51) Int. Cl. H04Q 7/00

(52) U.S. Cl. 370/331; 455/436; 455/434

(57) ABSTRACT

An apparatus and method of processing handover of a mobile relay station (MRS) in a cellular communication system using a multihop relay scheme is provided. The handover processing method includes transmitting, by the MRS, a handover request message containing child node information to a serving BS when handover is required; making, by the serving BS, an adjacent node list by collecting handover-related information from adjacent nodes to which the MRS is able to be handed over when the handover request message is received; transmitting, by the serving BS, a handover response message containing the adjacent node list to the MRS; and determining, by the MRS, a handover target node based on information contained in the handover response message and transmitting a handover indication message containing the target node to the serving BS. By suggesting the handover method of the MRS in the multihop relay system, it is possible to provide uninterrupted communication to the MRS and its child node in the service area of the MRS.

### PRIORITY

This application claims the benefit under 35 U.S.C. § 119 (a) from Korean Patent Application No. 2005-105808 filed on Nov. 7, 2005 in the Korean Intellectual Property Office, the contents of which are incorporated herein by reference.

### BACKGROUND OF THE INVENTION

1. Field of the Invention

The present invention generally relates to a broadband wireless access (BWA) communication system using a multihop relay scheme. More particularly, the present invention relates to an apparatus and method of processing handover of a mobile relay station in a BWA communication system using a multihop relay scheme.

2. Description of the Related Art

In fourth generation (4G) communication systems, researches is being conducted to provide users with various Quality of Service (QoS) at a data rate of over 100 Mbps. Specifically, research into the high rate service support to guarantee mobility and QoS in broadband wireless access (BWA) communication systems such as local area networks (LAN) and metropolitan area networks (MAN) is under way. Representative systems of the BWA communication system include Institute of Electrical and Electronics Engineers (IEEE) 802.16d and 802.16e communication systems.

The IEEE 802.16d and 802.16e communication systems adapt on Orthogonal Frequency Division Multiplexing (OFDM)/Orthogonal Frequency Division Multiple Access (OFDMA) scheme for physical channels. The IEEE 802.16d communication system addresses the stationary or fixed subscriber station (SS); that is, it does not take into account the mobility of the SS but the single cell structure. By contrast, the IEEE 802.16e communication system addresses the mobility of the SS, which is updated from the IEEE 802.16d communication system. The mobile SS is referred to as a mobile station (MS).

FIG. 1 is a simplified diagram of a general IEEE 802.16e communication system.

Referring to FIG. 1, the IEEE 802.16e communication system has a multi cell architecture, that is, a cell 100 and a cell 150. The IEEE 802.16 communication system includes a base station (BS) 110 managing the cell 100, a BS 140 managing the cell 150, and a plurality of MSs 111, 113, 130, 151, and 153. Signals are transmitted and received between the BSs 110 and 140 and the MSs 111, 113, 130, 151, and 153 using the OFDM/OFDMA scheme. Of the MSs 111, 113, 130, 151, and 153, the MS 130 resides in the overlapping area of the cell 100 and the cell 150; that is, in the handover region. When the MS 130 migrates to the cell 150 managed by the BS 140 while transmitting and receiving signals to and from the BS 110, the serving BS is changed from the BS 110 to the BS 140.

Signaling through the direct links between the fixed BS and the MSs as shown in FIG. 1, the general IEEE 802.16e communication system can easily configure highly reliable wireless communication links between the BS and the MSs. However, since the position of the BS is fixed, the IEEE 802.16e communication system has low flexibility in the radio network configuration. Thus, it is hard to provide efficient communication services in a radio communication environment suffering severe changes of traffic distribution or traffic demand.

To overcome these shortcomings, a data delivery scheme using a multihop relay having a fixed relay station, a mobile relay station, or general MSs is applicable to the general cellular wireless communication system such as IEEE 802.16e communication system. The wireless communication system using the multihop relay scheme can reconfigure the network by promptly coping with the changes of the communication environment and utilize the entire radio network more efficiently. For instance, the wireless communication system using the multihop relay is able to expand the cell service area and increase the system capacity. In detail, under poor channel conditions between the BS and the MS, better radio channel status can be provided to the MS by installing a relay station between the BS and the MS and establishing a multihop relay path via the relay station. Also, by adapting the multihop relay scheme in the cell boundary of the poor channel status from the BS, a high speed data channel can be provided and the cell service area can be expanded.

Hereinafter, descriptions are provided on a structure of a wireless communication system which uses the multihop relay scheme for expanding the service area of the BS.

FIG. 2 is a simplified diagram of a broadband wireless communication system using the multihop relay scheme for extending the service area of the BS.

Referring to FIG. 2, the multihop relay wireless communication system has a multicell architecture, that is, a cell 200 and a cell 240. The multihop relay wireless communication system includes a BS 210 managing the cell 200, a BS 250 managing the cell 240, MSs 211 and 213 located in the cell 200, MSs 221 and 223 managed by the BS 210 but located in an area 230 out of the cell 200, a relay station 220 providing multihop relay paths between the BS 210 and the MSs 221 and 223 in the area 230, MSs 251, 253 and 255 located in the cell 240, MSs 261 and 263 managed by the BS 250 but located in an area 270 out of the cell 240, and a relay station 260 providing multihop relay paths between the BS 250 and the MSs 261 and 263 in the area 270. Herein, signals are transmitted and received among the BSs 210 and 250, the relay stations 220 and 260, and the MSs 211, 213, 221, 223, 251, 253, 261, and 263 using the OFDM/OFDMA scheme.

The MSs 211 and 213 and the relay station 220, which belong to the cell 200, can transmit and receive signals directly to and from the BS 210, whereas the MSs 221 and 223 can not transmit and receive signals directly to and from the BS 210. Hence, the relay station 220 manages the area 230 and relays signals between the BS 210 and the MSs 221 and 223 which are incapable of transceiving signals directly. The MSs 221 and 223 can transceive signals with the BS 210 via the relay station 220. Likewise, the MSs 251, 253 and 255 and the relay station 260, which belong to the cell 240, can transmit and receive signals directly to and from the BS 250, whereas the MSs 261 and 263 in the area 270 can not transmit and receive signals directly to and from the BS 250. Hence, the relay station 260 manages the area 270 and relays signals between the BS 250 and the MSs 261 and 263 which are incapable of transceiving signals directly. The MSs 261 and 263 can transmit and receive signals to and from the BS 250 via the relay station 260.

In the following, a structure of a wireless communication system using the multihop relay scheme for expanding the system capacity is illustrated.

FIG. 3 is a simplified diagram of a broadband wireless communication system using the multihop relay scheme for expanding the system capacity.

Referring to FIG. 3, the multihop relay wireless communication system includes a BS 310, MSs 311, 313, 321, 323, 331 and 333, and relay stations 320 and 330 which provide multihop relay paths between the BS 310 and the MSs 311,313,321,323,331 and 333. Signals are transmitted and received among the BS 310, the relay stations 320 and 330, and the MSs 311, 313, 321, 323, 331 and 333 according to the OFDM/OFDMA scheme. The BS 310 manages a cell 300. The MSs 311, 313, 321, 323, 331 and 333 and the relay stations 320 and 330, belonging to the cell 300, are capable of transmitting and receiving signals directly to and from the BS 310.

However, when some MSs 321, 323, 331 and 333 reside close to the boundary of the cell 300, a Signal-to-Noise Ratio (SNR) of the direct links between the BS 310 and the some MSs 321, 323, 331 and 333 may lower. Thus, the relay station 320 relays the unicast traffic of the BS 310 and the MSs 321 and 323, and the MSs 321 and 323 transmit and receive the unicast traffic to and from the BS 310 via the relay station 320. Likewise, the relay station 330 relays the unicast traffic of the BS 310 and the MSs 331 and 333, and the MSs 331 and 333 transmit and receive the unicast traffic to and from the BS 310 via the relation station 330. That is, the relay stations 320 and 330 raise the effective data rate of the MSs and increase the system capacity by providing high-speed data delivery paths to the MSs 321, 323, 331 and 333.

In the broadband wireless communication system using the multihop relay scheme of FIGS. 2 or 3, the relay stations 220, 260, 320 and 330 may be infrastructure relay stations which are installed by a service provider and already known to the BSs 210, 250 and 310 for management, or client relay stations which serve as subscriber terminals (e.g., SSs or MSs) in some cases and relay stations in other cases. The relay stations 220, 260, 320 and 330 may be fixed relay stations, nomadic relay stations (e.g., notebook computers), or mobile relay stations such as MSs.

As discussed above, the relay station, which relays communications between the terminal and the BS, can be mobile. Accordingly, a mobile relay station may move out of the service area of the BS or the parent relay station. When the mobile relay station migrates to the service area of a new parent relay station or a neighbor BS, it is necessary to hand over the mobile relay station to ensure uninterrupted services to a terminal belonging to the service area of the mobile relay station or a child relay station. In other words, when addressing the mobile relay station in the wireless communication system using the multihop relay, it is required to define a procedure to effectively hand over the mobile relay station.

### SUMMARY OF THE INVENTION

The present invention has been provided to address the above-mentioned and other problems and disadvantages occurring in the conventional arrangement, and an aspect of the present invention is to provide an apparatus and method of handing over a mobile relay station in a broadband wireless access (BWA) communication system using a multihop relay scheme.

Another aspect of the present invention is to provide an apparatus and method of providing uninterrupted communication services to a mobile relay station handed over to a target node and to a child node belonging to a service area of the relay station in a BWA communication system using a multihop relay scheme.

Still another aspect of the present invention is to provide an apparatus and method of processing handover of a mobile relay station according to cell loading or relocation of the relay station in a BWA communication system using a multihop relay scheme.

According to an aspect of the present invention, a communication method of a mobile relay station (MRS) in a cellular communication system using a multihop relay scheme includes transmitting a handover request message including child node information to a serving base station (BS) when handover is required; receiving a handover response message including an adjacent node list from the serving BS; determining a handover target node based on information contained in the handover response message; and transmitting a handover indication message including the target node to the serving BS.

According to another aspect of the present invention, a communication method of a serving BS in a cellular communication system using a multihop relay scheme includes receiving a handover request message containing child node information from an MRS; making an adjacent node list by collecting handover-related information from adjacent nodes to which the MRS is able to be handed over when the handover request message is received; transmitting a handover response message including the adjacent node list to the MRS; and receiving a handover indication message including a handover target node from the MRS.

According to still another aspect of the present invention, an MRS apparatus in a cellular communication system using a multihop relay scheme includes a message generator which generates a handover request message containing child node information when handover is required; a transmitter which converts the message generated at the message generator according to a prescribed wireless standard and sends the converted message via an antenna; a message processor which extracts an adjacent node list from a handover response message received from a serving BS after the handover request message is transmitted; and a handover processor which determines a handover target node based on the adjacent node list

According to still another aspect of the present invention, a BS apparatus in a cellular communication system using a multihop relay scheme includes a handover processor which, when a handover request message containing child node information is received from an MRS, makes an adjacent node list by collecting handover-related information from adjacent nodes to which the MRS is able to be handed over; a message generator which generates a handover response message containing the adjacent node list; and a transmitter which processes the message generated at the message generator according to a prescribed wireless standard and transmits the processed message via an antenna.

According to still another aspect of the present invention, a handover processing method of an MRS in a cellular communication system using a multihop relay scheme includes transmitting, by the MRS, a handover request message containing child node information to a serving BS when handover is required; making, by the serving BS, an adjacent node list by collecting handover-related information from adjacent nodes to which the MRS is able to be handed over when the handover request message is received; transmitting, by the serving BS, a handover response message containing the adjacent node list to the MRS; and determining, by the MRS, a handover target node based on information contained in the handover response message and transmitting a handover indication message containing the target node to the serving BS.

### BRIEF DESCRIPTION OF THE DRAWING FIGURES

These and/or other aspects and advantages of the present invention will become apparent and more readily appreciated from the following description of the preferred embodiments, taken in conjunction with the accompanying drawings in which:

FIG. 1 is a simplified diagram of a general IEEE 802.16e communication system;

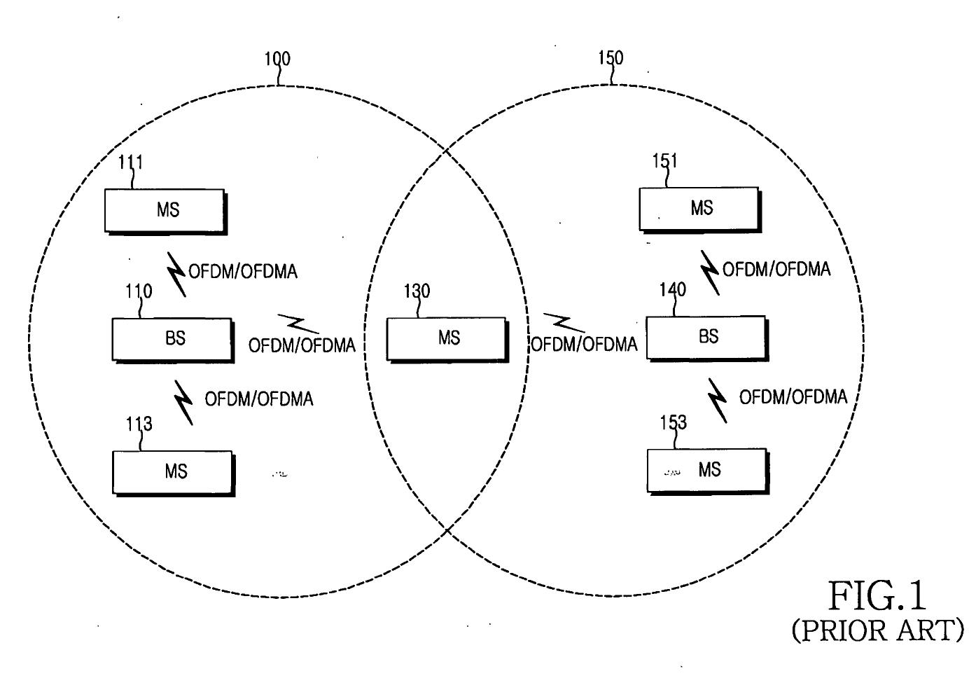

FIG. 2 is a simplified diagram of a broadband wireless communication system using a multihop relay scheme to expand a service area of a BS;

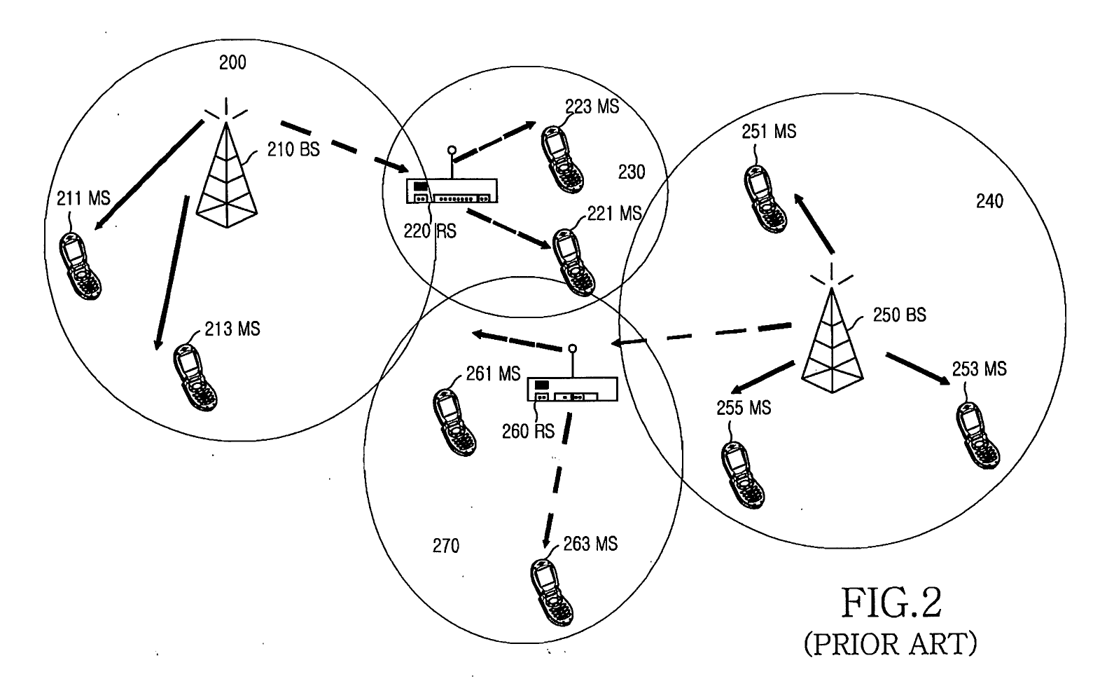

FIG. 3 is a simplified diagram of a broadband wireless communication system using the multihop relay scheme to increase system capacity;

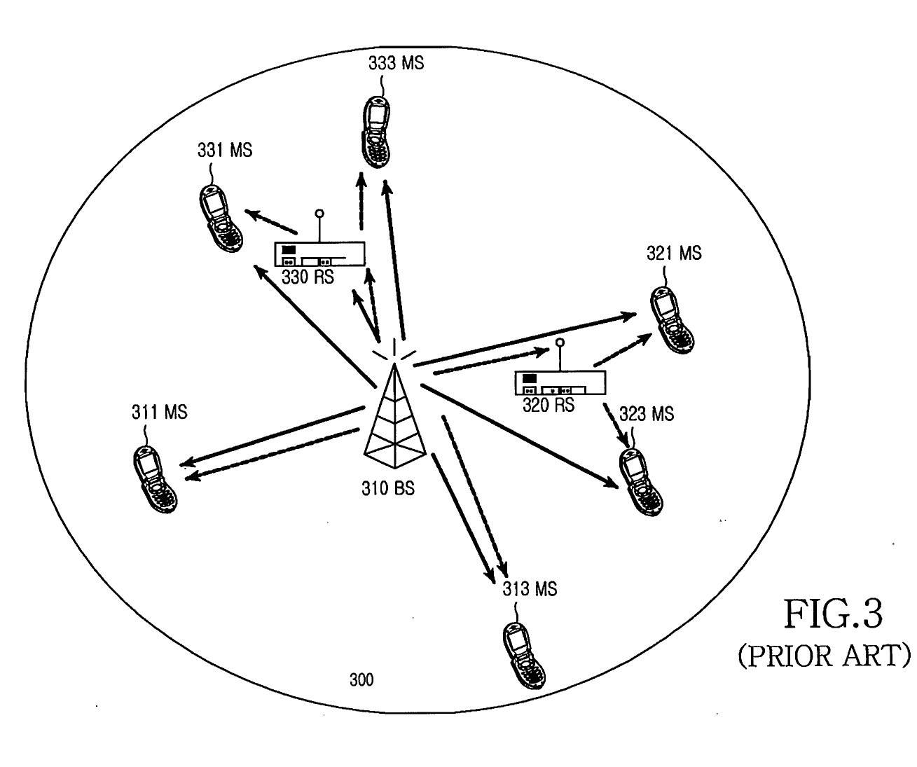

FIG. 4 is a flowchart outlining operations of a mobile relay station executing handover in a broadband wireless communication system using a multihop relay scheme according to the present invention;

FIG. 5 is a flowchart outlining operations of a serving BS processing a handover request of a mobile relay station in the broadband wireless communication system using the multihop relay scheme according to the present invention;

FIG. 6 is a flowchart outlining operations of a parent relay station relaying the handover request of the mobile relay station in the broadband wireless communication system using the multihop relay scheme according to the present invention;

FIG. 7 is a flowchart outlining operations of a BS belonging to an adjacent cell of the mobile relay station in the broadband wireless communication system using the multihop relay scheme according to the present invention;

FIG. 8 is a flowchart outlining operations of an adjacent relay station receiving handover feasibility of the mobile relay station in the broadband wireless communication system using the multihop relay scheme according to the present invention; and

FIG. 9 is a block diagram of a relay station or a BS according to the present invention.

### DETAILED DESCRIPTION OF THE PREFERRED EMBODIMENTS

Preferred embodiments of the present invention are provided to assist in a comprehensive understanding of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The present invention provides a signaling procedure for processing handover of a mobile relay station (MRS) in a broadband wireless access (BWA) communication system using a multihop relay scheme.

Herein, the BWA communication system using the multihop relay adapts Orthogonal Frequency Division Multiplexing (OFDM) or Orthogonal Frequency Division Multiple Access (OFDMA) by way of example. Using the OFDM/OFDMA scheme, the BWA communication system using the multihop relay is able to deliver data at a high rate and support mobility of a mobile station (MS) by virtue of a multicell architecture by transmitting physical channel signals using a plurality of sub-carriers.

Although the following explanations exemplify the BWA communication system, the present invention is applicable any other cellular-based communication systems using the multihop relay.

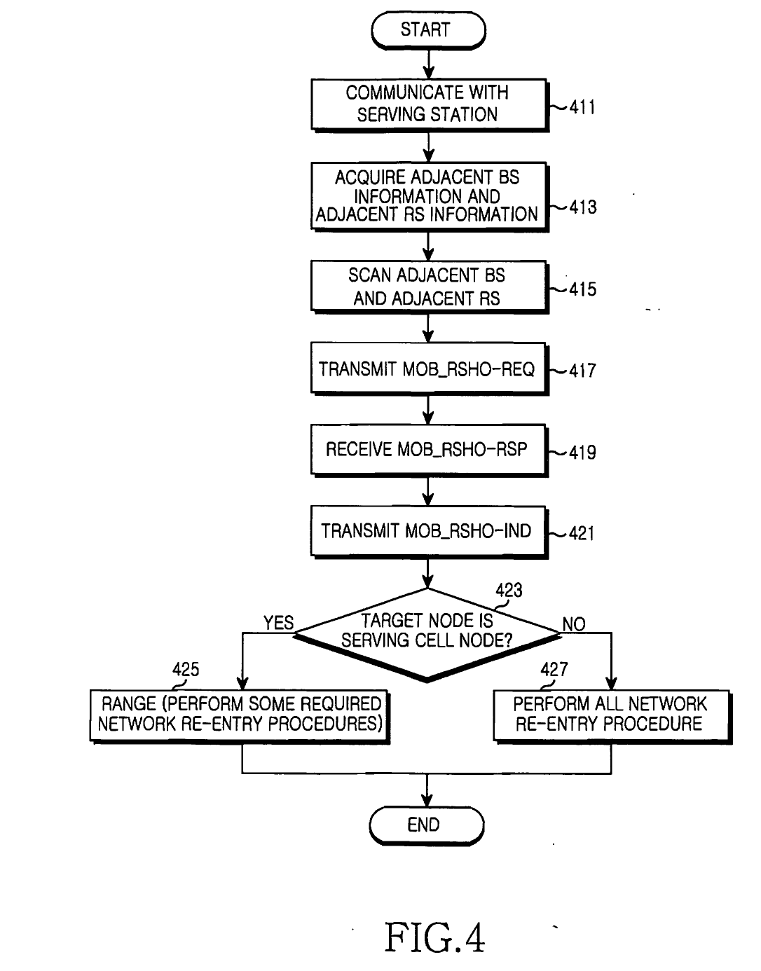

FIG. 4 is a flowchart outlining operations of an MRS which executes handover in a broadband wireless communication system using a multihop relay scheme according to the present invention.

Referring first to FIG. 4, the MRS executes communications with a serving station at step 411. Note that the serving station in communication with the MRS can be a parent RS or a serving BS. During the communications, the MRS acquires adjacent BS information and adjacent RS information from the serving stationat step 413.

Next, the MRS determines handover feasibility by scanning to measure signal strength with respect to the adjacent BS and the adjacent RS at step 415. When the MRS discovers an adjacent node having the better signal strength than the current serving station or detects an adjacent node which can process the handover with a signal strength over a threshold enough to request the handover, the MRS transmits a RS handover request (MOB_RSHO-REQ) message to the serving station to request the handover at step 417. Finally, the MOB_RSHO-REQ message is received at the serving BS.

Table 1 shows the MOB_RSHO_REQ message format.

TABLE 1

| Syntax | Size (bits) | Notes |
|---|---|---|
| MOB_RSHO-REQ_Message( ) { | | |
| Management message type = TBD | 8 | To be determined |
| RS_ID | TBD | Requester RS's Identifier (RS CID or RS MAC address, etc.) |
| N_Candidate_Node | 8 | Number of candidate nodes recommended by the RS |
| For(i=0; i<N_Candidate_Node; | | |
| i++) { | | |
| Node ID | TBD | Candidate node's Identifier (Node MAC address, preamble index, |
| | | etc.) |
| Signal measurement values | TBD | CINR, RSSI, relative delay, RTD, etc. |
| } | | |
| Including_Child_Node | 1 | This field indicates whether the requester RS manages other nodes |
| | | (RS or MS or SS). |
| | | 0: no child node |
| | | 1: child nodes exist |
| Reserved | 7 | Shall be set to zero |
| } | | |

In Table 1, the MOB_RSHO-REQ message contains IEs (Information Elements), specifically, a message type for identifying the transmitted message (Management Message Type), an ID of the MRS (RS_ID), the number of adjacent candidate target nodes recommended by the MRS (N_Candidate_Node), an adjacent node list, and child node information which receives relay service from the MRS to be handed over (Including_Child_Node). The information of the adjacent node included in the adjacent node list recommended by the MRS as the target node contains an ID (MAC address or preamble index) and signal strength measurement information (Signal measurement values) of the adjacent node. The signal strength measurement information of the adjacent node can contain Carrier-to-Interference and Noise Ratio (CINR), Received Signal Strength Indication (RSSI), relative delay, or Round Trip Delay (RTD). Note that the adjacent nodes can cover the BS of the adjacent nodes, the RS of the adjacent cell, the serving BS, and the adjacent RS of the serving cell. The child node information of the MRS indicates whether there is a child node to which the relay service is to be provided continuously even after the MRS conducts the handover. If necessary, the child node information of the MRS may contain IDs of the child nodes and the requested service levels.

After transmitting the MOB_RSHO-REQ message to the serving station, the MRS receives a RS handover response (MOB_RSHO-RSP) message from the serving station at step 419.

Table 2 shows the MOB_RSHO-RSP message format

TABLE 2

| Syntax | Size (bits) | Notes |
|---|---|---|
| MOB_RSHO-RSP_Message( ) { | | |
| Management message type = | 8 | To be determined |
| TBD | | |
| RS_ID | TBD | Requester RS's Identifier (RS CID or RS MAC address, etc.) |
| N_Candidate_Node | 8 | Number of candidate nodes recommended by serving BS |
| For(i=0; i<N_Candidate_Node; | | |
| i++) { | | |
| Node ID | TBD | Candidate node's Identifier (Node MAC address, preamble index, etc.) |
| RS capability | TBD | RS capability after performing handover to the candidate node. (this |
| | | parameter may indicate the type/feature of relay station.) |
| | | 0: RS capability off |
| | | 1: RS capability on |
| Estimated service level | TBD | available service level provided by the candidate node |
| } | | |
| } | | |

In Table 2, the MOB_RSHO-RSP message contains IEs, specifically, a message type for identifying the transmitted message (Management Message Type), an ID of the MRS (RS_ID), the number of adjacent nodes recommended by the serving station as the handover target node (N_Candidate_Node), and an adjacent node list. The adjacent node information included in the adjacent node list contains an ID of the adjacent node (MAC address or preamble index), RS capability information indicating whether the MRS continues to function as the RS when handed over to the adjacent node, and an available service level when the MRS conducts the handover to the corresponding adjacent node. The RS capability information can contain not only the RS capability on/off information but also detailed capability information executable when the MRS is handed over. Herein, the adjacent nodes can cover the BS of the adjacent cell, the RS of the adjacent cell, the serving BS, and the adjacent RS of the serving cell.

When the MRS ceases to function as the RS after conducting the handover to the adjacent node, it needs to forcibly hand over its child nodes which communicate using the MRS as the serving station. Since the forced handover time and procedure of the child nodes are not directly related to the present invention, further descriptions shall be omitted for conciseness.

After receiving the MOB_RSHO-RSP message, the MRS selects a target node for handover and transmits a RS HO INDICATION (MOB_RSHO-IND) message including information of the target node to the serving station at step 421. The target node can be selected by taking into account various criteria all together, such as the signal strength acquired through the scanning, the RS capability in the handover, or the available service level provided in the handover. Finally, the MOB_RSHO-IND message is received at the serving BS.

Table 3 shows the MOB_RSHO-IND message format

TABLE 3

| | Size | |
|---|---|---|
| Syntax | (bits) | Notes |
| MOB_RSHO-IND_Message( ) { | | |
| Management message type = | 8 | To be determined |
| TBD | | |
| RS_ID | TBD | RS's Identifier (RS CID or |
| | | RS MAC address, etc.) |
| Target Node ID | TBD | Target node's Identifier |
| | | (Node MAC address, |
| | | preamble index, etc.) |
| Including_Child_Node | 1 | This field indicates whether |
| | | the requester RS manages |
| | | other nodes (RS or MS |
| | | or SS). |
| | | 0: no child node |
| | | 1: child nodes exist |
| Reserved | 5 | Shall be set to zero |
| } | | |

In Table 3, the MOB_RSHO-IND message contains IEs, specifically, a message type for identifying the transmitted message (Management Message Type), an ID of the MRS (RS_ID), an ID of the target node for the handover (CID, MAC address, or preamble address), and child node information of the MRS which conducts the handover (Including_Child_Node). The child node information indicates whether there is a child node to receive the uninterrupted relay service even after the MRS is handed over. If necessary, the child node information can contain IDs of the child nodes. When the MRS selects the target node to the adjacent node which can not function as the RS after the handover according to the information contained in the MOB_RSHO-RSP message (Table 2), it needs to set that there is no child node to be handed over to.

After transmitting the MOB_RSHO-IND message to the serving station, the MRS determines whether the target node defined in the MOB_RSHO-IND message is a serving cell node at step 423. When the target node is the serving cell node, the MRS performs network re-entry procedures with the target node at step 425. In doing so, the MRS performs a ranging procedure with the target node and some network reentry procedures required for communications with the target node such as negotiating basic capabilities, connection ID update, and authentication. By contrast, when the target node is not the serving cell node, the MRS performs the network re-entry procedures with the target node at step 427. The network reentry procedures in steps 425 and 427 may be the same. Yet, since the MRS is already registered to the serving BS when the target node is the serving cell node, the network reentry procedure in step 425 can omit some steps, compared with the network reentry procedure of the adjacent cell in step 427.

When a child station or a child RS managed by the MRS is handed over to the adjacent node together with the MRS, the MRS can provide its child node information to the target node in the network re-entry procedures of steps 425 or 427. Particularly, when the MRS and its child node are handed over to the target node of the adjacent cell, the MRS can perform the network reentry procedure for the child node of the MRS during the network re-entry procedures of step 427. In other words, without recognizing the handover to the target node, the child node of the MRS executes the network re-entry procedure to the target node through the MRS.

For the network re-entry procedure for the MRS's child node, the MRS transmits the information of the child node to the target node in the adjacent cell if necessary. The MRS provides information to inform the target node of the adjacent cell, of the basic negotiation capabilities of the child node, and if necessary, the MRS and the target node of the adjacent cell exchange authentication information of the child node. The MRS transmits the information of the child node to the adjacent cell BS to register the child node in the adjacent cell BS. As such, the network re-entry procedure information of the child node can contain the basic negotiation capabilities information, the authentication information, and the registration information of the child node, and the service information provided to the child node. That is, the information exchanged in the network re-entry procedure contains the information required to provide the uninterrupted service to the child node during the handover of the MRS.

The information of the child node which is handed over to the target node of the adjacent cell and managed by the MRS can be exchanged during the network re-entry in step 427 or the backbone signaling between the serving BS of the MRS and the BS of the target node in the handover negotiation of the MRS. Upon receiving the child node information, the target node or the BS of the target node can request the detailed information of the child node of the MRS executing the handover to the serving BS or a system which manages the serving BS, if necessary.

In the present invention, the MRS determines the handover request when it discovers the adjacent node has a better signal strength than the serving station or when it receives a signal from the adjacent node over the handover request threshold, by way of example. Note that the criterion for determining the handover request of the MRS may differ according to the system setup and other various criteria can be considered besides the above-mentioned criterion

Although the MRS initiates the handover by way of example, the BS is able to initiate the handover. Initiating the handover of the MRS, the BS sends the MOB_RSHO-RSP message of Table 2 to the MRS and the MRS informs of the handover initiated by the BS by sending the MOB_RSHO-IND message of Table 3. The MOB_RSHO-RSP message of Table 2, which is transmitted from the BS to the MRS to request the handover execution, can include target node (target BS or target RS) information recommended by the BS, service level information provided from the target node to the MRS, service level information provided to a child node managed by the MRS, and so forth. Those information can be contained in a handover control message transmitted between the BS and the target node (the target BS or the target RS).

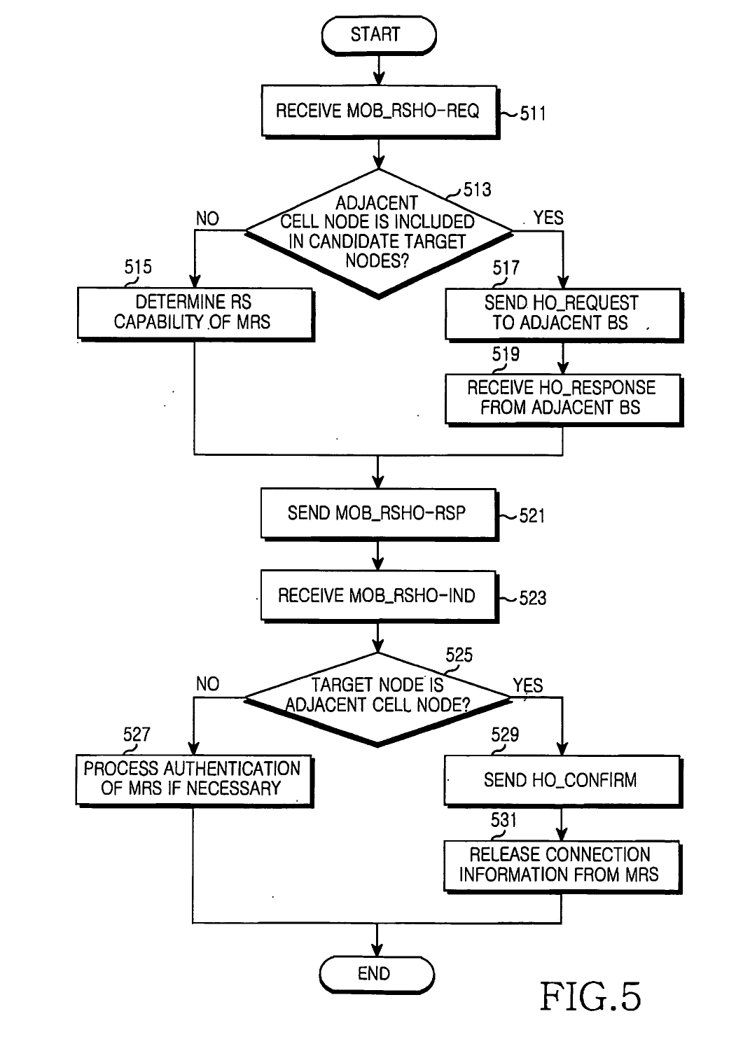

FIG. 5 is a flowchart outlining operations of the serving BS which processes the handover request of the MRS in the broadband wireless communication system using the multihop relay scheme according to the present invention.

Referring to FIG. 5, the serving BS receives the MOB_RSHO-REQ message (see, Table 1) from the MRS at step 511. The serving BS determines whether the adjacent cell node is included in the adjacent node list recommended by the MRS as the handover target node and contained in the received MOB_RSHO-REQ message at step 513. Note that the adjacent cell node can be the adjacent cell BS or the adjacent cell RS.

When the adjacent cell node is not included in the MOB_RSHO-REQ message, the serving BS selects candidate nodes of the serving cell to which the MRS can be handed over, and determines whether the MRS is able to continue to function as the RS when handed over to the candidate nodes in step 515. Whether to function as the RS can be determined based on the service area expansion and the system capacity increase of the serving BS.

When the adjacent cell node is defined in the MOB_RSHO-REQ message, the serving BS transmits a handover (HO)-request message, which informs the handover request of the MRS, to the adjacent cell BS which manages the adjacent cell node defined in the MOB_RSHO-REQ message over a backbone network at step 517.

Table 4 shows the HO-request message format.

TABLE 4

| | Size | |
|---|---|---|
| Syntax | (bits) | Notes |
| HO_request_Message( ) { | | |
| Global header | Variable | Backbone message's header |
| For(i=0; i<Num Records; i++) { | | |
| RS_ID | 48 | RS's Identifier (RS MAC address, etc.) |
| RS capability | 5 | Bit #0: RS support (0: no support 1: RS capability support) |
| | | Bit #1: Infrastructure RS |
| | | Bit #2: Client RS |
| | | Bit #3: Nomadic RS |
| | | Bit #4: Mobile RS |
| Including_Child_Node | 1 | This field indicates whether the RS manages other nodes (RS or MS or |
| | | SS). |
| | | 0: no child node |
| | | 1: child nodes exist |
| Reserved | 2 | Shall be set to zero |
| Required bandwidth | 8 | Bandwidth which required to guarantee minimum packet data |
| | | transmission |
| Required service level | 8 | |
| N_Candidate_Node | 8 | Number of candidate nodes in this neighbor BS(which are |
| | | recommended by the RS) |
| For(i=0; i<N_Candidate_Node; | | |
| i++) { | | |
| Node ID | TBD | Candidate node's Identifier (Node MAC address, preamble index, etc.) |
| } | | |
| } | | |
| } | | |

In Table 4, the HO-request message contains IEs, specifically, a message header indicating the backbone message (Global header), an ID of the MRS requesting the handover to the adjacent cell node (RS_ID), bandwidth required when the MRS conducts the handover to the adjacent cell node, service level required when the MRS conducts the handover to the adjacent cell node, detailed capability information of the MRS (RS capability), information indicating whether a child node is included when the MRS is handed over to the adjacent cell (Including_Child_Node), the number of adjacent nodes to which the MRS can be handed over (N_Candidate_Node), and IDs of the adjacent nodes (MAC address or preamble index). Herein, the adjacent nodes can cover an adjacent cell BS which receives the HO-request message from the serving BS, and an adjacent cell RS managed by the adjacent cell BS. Also, the adjacent nodes can cover the ID of the child node and the service level required by the child node when it includes the child node information of the MRS.

In the meantime, Table 5 shows a format of the backbone message header (Global header) contained in the backbone message which is transmitted over the backbone network, similar to the HO-request message.

TABLE 5

| Field | Size (bits) | Notes |
|---|---|---|
| Message type = TBD | 8 | To be determined |
| Sender BS ID | 48 | Sender base station identifier |
| Target BS ID | 48 | Target base station identifier |
| Time Stamp | 32 | Number of milliseconds since |
| | | midnight GMT (set to 0xffffffff to |
| | | ignore) |
| Num Records | 16 | Number of MS identity records |

As shown in Table 5, the backbone message header (Global header) contains IEs, specifically, a message type for identifying the transmitted message, a BS ID which sends the message (Sender BS ID), a BS ID which receives the message (Target BS ID), a time stamp of the message, and the number of records indicating the number of MRS information in the message (Num Records).

After transmitting the HO-request message, the serving BS receives an HO-response message from the adjacent cell BS at step 519.

A format of the HO-response message is shown in Table 6.

TABLE 6

| | Size | |
|---|---|---|
| Syntax | (bits) | Notes |
| HO_response_Message( ) { | | |
| Global header | Variable | Backbone message's header |
| For(i=0; i<Num Records; i++) { | | |
| RS_ID | 48 | RS's Identifier (RS MAC address, etc.) |
| N_Candidate_Node | 8 | Number of candidate nodes in this neighbor BS(which are recommended |
| | | by the RS) |
| For(i=0; i<N_Candidate_Node; | | |
| i++) { | | |
| Node ID | TBD | Candidate node's Identifier (Node MAC address, preamble index, etc.) |
| Estimated bandwidth | 8 | Bandwidth which is provided by this node to guarantee minimum packet |
| | | data transmission |
| Estimated service level | 8 | Service level which is provided by this node |
| RS capability | 5 | Bit #0: RS support (0: no support 1: RS capability support) |
| | | Bit #1: Infrastructure RS |
| | | Bit #2: Client RS |
| | | Bit #3: Nomadic RS |
| | | Bit #4: Mobile RS |
| Reserved | 3 | Shall be set to zero |
| } | | |
| } | | |
| } | | |

In Table 6, the HO-response message contains IEs, specifically, a message header indicating it is the backbone message (Global header), an ID of the MRS requesting the handover to the adjacent cell node (RS_ID), the number of adjacent cell nodes for the handover of the MRS (N_Candidate_Node), and an adjacent node list. The adjacent cell node information included in the adjacent node list contains a node ID (MAC address, preamble index, etc.), bandwidth provided to the MRS by the adjacent cell node, service level provided to the MRS by the adjacent cell node, and detailed capability information of the RS when the MRS conducts the handover to the adjacent cell node (RS capability). The detailed capability information of the MRS is defined by referring to the detailed capability information of the RS (RS capability) in the HO-request message (see, Table 5), and should be a subset of the RS detailed capability information defined in the HO-request message. Herein, the adjacent cell nodes can cover an adjacent cell BS and an adjacent cell RS managed by the adjacent cell BS. Also, the HO-response message can include the service level information which the adjacent cell node can support for the child node of the MRS.

Next, the serving BS sends a MOB_RSHO-RSP message (see, Table 2) containing the collected information of the adjacent nodes in steps 515 through 519, to the MRS in step 521. Herein, when the MRS communicates directly with the serving BS, the MOB_RSHO-RSP message is transmitted directly to the MRS. By contrast, when the serving BS does not communicate directly with the MRS, the MOB_RSHO-RSP message is delivered to the MRS through the relay of the RSs between the serving BS and the MRS. Next, the serving BS receives a MOB_RSHO-IND message (see, Table 3) in which whether to hand over the MRS is set in step 523.

Receiving the MOB_RSHO-IND message, the serving BS determines whether a target node set in the received MOB_RSHO-IND message is an adjacent cell node at step 525. When the target node is not the adjacent cell node, that is, when the target node is itself or a serving cell node, the serving BS performs necessary procedures of the network re-entry procedures at step 527. When the target node is the serving BS, the serving BS first performs ranging with the MRS and then performs other necessary network reentry procedures, such as negotiating base capabilities and connection ID update. When the target node is the serving cell node, the serving BS executes necessary procedures for the network re-entry between the MRS and the serving cell node.

Meanwhile, when the target node set in the received MOB_RSHO-IND message is the adjacent cell node, the serving BS transmits a HO-confirm message, which informs the handover of the MRS, to an adjacent cell BS managing the adjacent cell node over the backbone network at step 529.

Table 7 shows a format of the HO-confirm message.

TABLE 7

| | Size | |
|---|---|---|
| Syntax | (bits) | Notes |
| HO_confirm_Message( ) | | |
| { | | |
| Global header | Variable | Backbone message's header |
| RS_ID | 48 | RS's Identifier (RS MAC address, etc.) |
| Including_Child_Node | 1 | This field indicates whether the RS manages other nodes (RS or MS or SS). |
| | | 0: no child node |
| | | 1: child nodes exist |
| Reserved | 7 | Shall be set to zero |
| Target Node ID | TBD | Target node's Identifier (Node MAC address, preamble index, etc.) |
| Estimated bandwidth | 8 | Bandwidth which is provided by the target node to guarantee minimum packet data |
| | | transmission |
| Estimated service level | 8 | Service level which is provided by the target node |
| } | | |

In Table 7, the HO-confirm message contains IEs, specifically, a message header indicating the backbone message (Global header), an ID of the MRS for handover (RS_ID), child node information indicating whether there is child node to be handed over together with the MRS, an ID of a target node to which the MRS is handed over (MAC address, preamble index, etc.), bandwidth provided by the target node when the MRS is handed over, and service level provided by the target node when the MRS is handed over. Note that the target node can be an adjacent cell BS or an adjacent cell RS managed by the adjacent cell BS. The bandwidth and the service level provided by the target node are equal to the bandwidth and the service level as set in the HO-response message (see, Table 6). When the HO-response message includes the child node of the MRS, service level information for the child node of the MRS which is set in the HO-response can also be included.

As above, after informing the adjacent cell BS of the MRS' handover, the serving BS releases the connection resources from the MRS at step 531.

In the present invention, when the serving cell node is included in the adjacent node list of the MOB_RSHO-REQ message, the serving BS can send a relay station handover inform (RSHO-INFORM) message to the serving cell nodes of the adjacent node list in order to determine the handover feasibility of the MRS.

Table 8 shows a format of the RSHO-INFORM message.

TABLE 8

| | Size | |
|---|---|---|
| Syntax | (bits) | Notes |
| RSHO-INFORM_Message( ) { | | |
| Management message type = | 8 | To be determined |
| TBD | | |
| RS ID | 48 | RS's Identifier (RS MAC address, etc.) |
| RS capability | 5 | Bit #0: RS support (0: no support 1: RS capability support) |
| | | Bit #1: Infrastructure RS |
| | | Bit #2: Client RS |
| | | Bit #3: Nomadic RS |
| | | Bit #4: Mobile RS |
| Including_Child_Node | 1 | This field indicates whether the RS manages other nodes (RS or MS or SS). |
| | | 0: no child node |
| | | 1: child nodes exist |
| Reserved | 2 | Shall be set to zero |
| Required bandwidth | 8 | Bandwidth which is required by MS (to guarantee minimum packet data |
| | | transmission) |
| Required service level | 8 | |
| } | | |

In Table 8, the RSHO-INFORM message contains IEs, specifically, a message type for identifying the transmitted message (Management Message Type), an ID of the handed-over MRS (RS_ID), detailed capability information of the MRS (RS capability), information relating to child nodes that can be handed over together with the MRS in the service area of the MRS (Including_Child_Node), bandwidth required when the MRS is handed over, and service level required when the MRS is handed over. When the child node information of the MRS is included, service level information required by the child node can also be included.

After transmitting the RSHO-INFORM message (see, Table 8), the serving BS receives a RSHO-INFORM acknowledgement (RSHO-INFORM-ACK) message from the serving cell nodes in response.

Table 9 shows a format of the RSHO-INFORM-ACK message.

TABLE 9

| | Size | |
|---|---|---|
| Syntax | (bits) | Notes |
| RSHO-INFORM- | | |
| ACK_Message( ) { | | |
| Management message type = | 8 | To be determined |
| TBD | | |
| RS ID | 48 | RS's Identifier (RS MAC address, etc.) |
| RS capability | 5 | Bit #0: RS support (0: no support 1: RS capability support) |
| | | Bit #1: Infrastructure RS |
| | | Bit #2: Client RS |
| | | Bit #3: Nomadic RS |
| | | Bit #4: Mobile RS |
| Estimated bandwidth | 8 | Bandwidth which is provided by the target node to guarantee minimum |
| | | packet data transmission |
| VEstimated service level | 8 | Service level which is provided by the target node |
| } | | |

In Table 9, the RSHO-INFORM-ACK message contains IEs, specifically, a message type for identifying the transmitted message (Management Message Type), an ID of the handed-over MRS (RS ID), detailed capability information of the handed-over MRS (RS capability), bandwidth provided by the target node when the MRS is handed over, and service level provided by the target node when the MRS is handed over. Note that the detailed capability information of the MRS (RS capability) can contain not only information indicating whether the MRS continuously serves as the RS when handed over but also capability information when the MRS is handed over. Also, it is noted that the detailed capability information should be a subset of the detailed capability information of the MRS as contained in the RSHO-INFORM message (see, Table 8). The RSHO-INFORM-ACK message can contain the child node information of the MRS and in this case service level information for the child node can also be included.

In the meantime, when the target node is the serving cell RS, the serving BS can inform the serving cell RS of the MRS handover. In doing so, the serving BS sends to the target node belonging to the serving cell a RSHO notification (RSHO-notify) message informing the MRS's handover.

Table 10 shows a format of the RSHO-notify message.

TABLE 10

| | Size | |
|---|---|---|
| Syntax | (bits) | Notes |
| RSHO_notify_Message( ) | | |
| { | | |
| RS_ID | 48 | RS's Identifier (RS MAC address, etc.) |
| RS Capability | 5 | Bit #0: RS support(0: no support 1: RS capability support) |
| | | Bit #1: Infrastructure RS |
| | | Bit #2: Client RS |
| | | Bit #3: Nomadic RS |
| | | Bit #4: Mobile RS |
| Including_Child_Node | 1 | This field indicates whether the RS manages other nodes (RS or MS or SS). |
| | | 0: no child node |
| | | 1: child nodes exist |
| Reserved | 2 | Shall be set to zero |
| Estimated bandwidth | 8 | Bandwidth which is provided by the target node to guarantee minimum packet data |
| | | transmission |
| Estimated service level | 8 | Service level which is provided by the target node |
| } | | |

In Table 10, the RSHO-notify message contains IEs, specifically, a message type for identifying the transmitted message (Management Message Type), an ID of the handed-over MRS (RS_ID), RS capability information including information whether the MRS still serves as the RS after the handover (RS capability), child node information handed over together with the MRS (Including_Child_Node), bandwidth provided by the target node when the MRS is handed over, and service level provided by the target node when the MRS is handed over. Note that the RS capability information including the information whether the MRS still serves as the RS after the handover, the bandwidth provided by the target node, and the service level provided by the target node are set to the same as the information of the RSHO-INFORM-ACK message (see, Table 9).

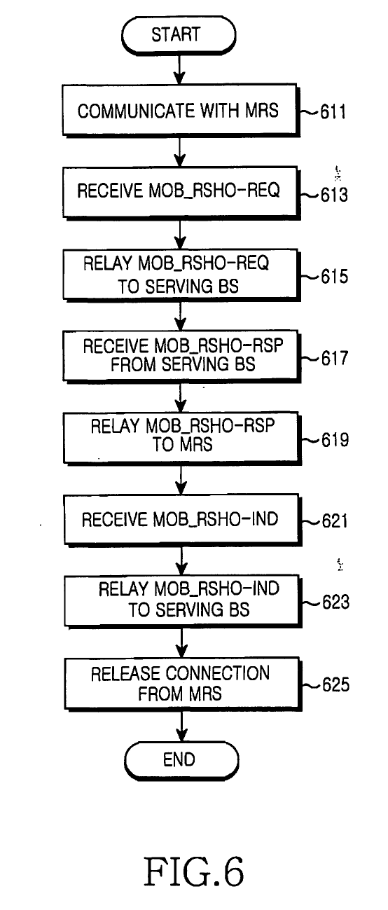

FIG. 6 is a flowchart outlining operations of a parent RS which relays the handover request of the MRS in the broadband wireless communication system using the multihop relay scheme according to the present invention.

Referring to FIG. 6, the parent RS relays communications between the MRS and the serving BS in step 611. During the relay communications, the parent RS receives a MOB_RSHO-REQ message (see, Table 1) from the MRS at step 613. The parent RS relays the received MOB_RSHO-REQ message to the serving BS at step 615.

After relaying the MOB_RSHO-REQ message, the parent RS receives a MOB_RSHO-RSP message (see, Table 2) from the serving BS in response to the MOB_RSHO-REQ message at step 617. The parent RS relays the received MOB_RSHO-RSP message to the MRS at step 619.

Next, the parent RS receives from the MRS a MOB_RSHO-IND message (see, Table 3) containing the information as to the handover target node finally selected by the MRS at step 621. The parent RS relays the received MOB_RSHO-IND message to the serving BS at step 623, and upon detecting the handover of the MRS, the parent RS releases the connection resources from the MRS at step 625. In the present invention, it is assumed that the parent RS can interpret messages exchanged between the handed-over MRS and the serving BS. In the case where the parent RS merely forwards messages exchanged between the MRS and the serving BS, the parent RS is not able to recognize the handover executed by the MRS. In this case, the serving BS can send a message informing the handover of the MRS to the parent RS.

Hereinafter, operations of a BS located in an adjacent cell of the handed-over MRS will be illustrated.

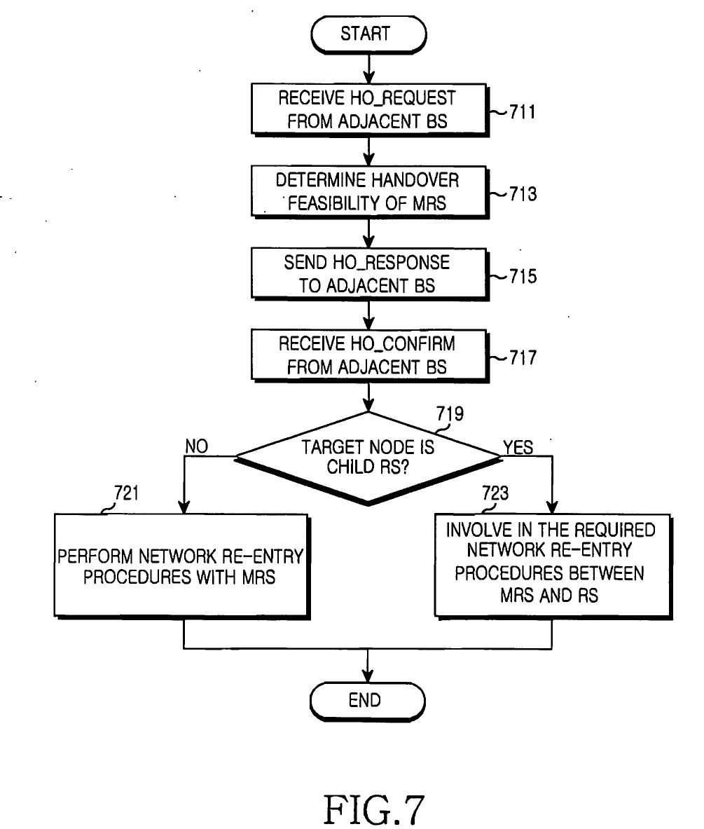

FIG. 7 is a flowchart outlining operations of a BS belonging to an adjacent cell of the MRS (an “adjacent cell BS”) in the broadband wireless communication system using the multihop relay scheme according to the present invention.

Referring to FIG. 7, the adjacent cell BS recognizes the handover request of the MRS by receiving the HO-request message (see, Table 4) from the serving BS of the MRS at step 711. Next, the adjacent cell BS determines whether the MRS can be handed over to the adjacent cell node defined in the received HO-request message at step 713. The handover feasibility of the MRS can be determined based on the requested bandwidth of the MRS, the requested service level, the detailed capability information of the MRS (RS capability), and the child node information of the MRS (Including_Child_Node), which are contained in the HO-request message, or other criteria set by the adjacent cell BS.

As such, after determining the handover feasibility, the adjacent cell BS sends the HO-response message (see Table 6) to the serving BS of the MRS in response to the received HO-request message at step 715. Note that the HO-response message contains the bandwidth and the service level that can be provided to the MRS when the MRS is handed over to a node managed by the adjacent cell BS, and the detailed capability information of the RS, and that the information contained in the HO-response message is used to select a target node to which the MRS is actually handed over. It is noted that the RS capability set in the HO-response message after the handover of the MRS should be a subset of the RS capability which is supported by the MRS and contained in the HO-request message (see, Table 4).

Next, the adjacent cell BS receives an HO-confirm message (see, Table 7), which informs of the handover execution, from the serving BS of the MRS at step 717. In doing so, the adjacent cell BS recognizes the MRS has determined to hand over to a node managed by the adjacent cell BS. Upon receiving the HO-confirm message, the adjacent cell BS determines whether the target node set in the received HO-confirm message is itself at step 719. When the adjacent cell node is the target node, it performs the network reentry procedures with the MRS at step 721. When the target node is an RS managed by the adjacent cell BS, the adjacent cell BS performs some procedures required for the MRS to carry out the network re-entry with the target node at step 723.

While performing the network reentry procedures in step 721, the adjacent cell BS can process the network reentry procedure information of an MRS's child node which is handed over together with the MRS. Alternatively, during the network reentry procedure in step 723, upon receiving the network re-entry procedure information of the MRS's child node, the adjacent cell BS can process the network re-entry procedure of the MRS's child node. The network re-entry procedure information of the child node can contain the basic negotiation capabilities information, the authentication information, and the registration information of the child node. In addition, the network reentry procedure information of the child node can contain the service information provided to the child node. Specifically, the information exchanged in the network re-entry procedure contains information required to provide uninterrupted services to the child node even when the MRS is handed over. Meanwhile, when receiving the information of the child node handed over together with the MRS during the network re-entry procedure with the MRS, the adjacent cell BS can request information required for the network reentry of the child node to the former serving cell BS through backbone signaling.

In the present invention, when the adjacent node list of the HO-request message received by the adjacent cell BS includes the information as to the RS managed by the adjacent cell BS, the adjacent cell BS can send the RSHO-INFORM message (see, Table 8) to the adjacent RS to determine whether to accept the handover of the MRS with respect to the adjacent RS. The adjacent cell BS receives the RSHO-INFORM-ACK message (see, Table 9) from the adjacent RS in response to the RSHO-INFORM message. More specifically, the adjacent cell BS can determine the handover feasibility of the MRS by referring to the bandwidth and the service level provided to the MRS, and the RS capability information after the handover, which are contained in the RSHO-INFORM-ACK message.

When the target node finally selected by the MRS is an RS managed by the adjacent cell BS, the adjacent cell BS can send the RSHO-notify message (see, Table 10) to the RS selected as the target node to inform the handover execution of the MRS.

The following explanations describe operations of an adjacent RS to which the MRS can be handed over. Herein, the adjacent RS belongs to an RS of the adjacent cell or a serving cell, and can be an RS other than a parent RS.

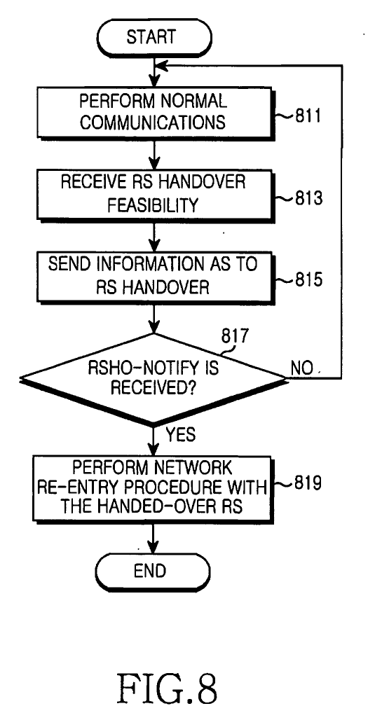

FIG. 8 is a flowchart outlining operations of an adjacent RS which receives handover feasibility of the MRS in the broadband wireless communication system using the multihop relay scheme according to the present invention.

Referring now to FIG. 8, the adjacent RS conducts a normal communication procedure at step 811. During the communications, the adjacent RS receives a RSHO-INFORM message (see, Table 8) informing the handover feasibility of the MRS from its serving station at step 813. In the direct communications with the serving BS, the serving station is the serving BS. In the relay communications with the BS via another RS, the serving station is a parent serving RS of the adjacent RS. The node transmitting the RSHO-INFORM message can be an MRS's serving BS which processes the handover of the MRS or an adjacent cell BS which manages the adjacent cell of the MRS.

Upon receiving the RSHO-INFORM message, the adjacent RS determines whether to accept the handover of the MRS based on the information contained in the received message, generates and sends a RSHO-INFORM-ACK message (see, Table 9) including the handover-related information of the MRS at step 815. The serving BS of the MRS or the serving BS of the adjacent RS makes the adjacent node list for the handover by using the handover-related information of the RSHO-INFORM-ACK message.

After transmitting the RSHO-INFORM-ACK message, the adjacent RS checks whether a RSHO-notify message (see, Table 10) informing the handover of the MRS is received at step 817. After receiving the RSHO-notify message, the adjacent RS executes the network reentry procedure with the MRS at step 819. Afterwards, the adjacent RS serves as the serving station of the MRS. By contrast, when the RSHO-notify message is not received, the adjacent RS returns to step 811 and performs normal communications.

When the BS itself determines whether to accept the MRS's handover by taking into account the bandwidth and the service level provided after the MRS's handover, or the RS function support, steps 813 to 817 of FIG. 8 may be omitted.

In the meantime, when the final target node of the MRS is the adjacent cell RS, it may need to exchange the network re-entry procedure information of the child node handed over to the adjacent cell RS together with the MRS in the network re-entry of step 819. The network re-entry procedure information of the child node can contain the basic negotiation capabilities, the authentication information, and the registration information of the child node. The network re-entry procedure information of the child node can provide the service information of the child node. That is, the information exchanged in the network re-entry procedure contains the information required to provide uninterrupted services to the child node even when the MRS is handed over. Accordingly, the adjacent cell RS needs to be able to receive and process the network reentry procedure information of the MRS's child node as well as the network re-entry procedure information of the MRS.

While the MRS executes the handover, a child node belonging to the cell managed by the MRS is not aware of the handover of the MRS. In other words, the handover of the MRS should guarantee the transparency to the child node. But, when the MRS conducts the handover between BSs, it is required to perform a registration procedure of the child node managed by the MRS in relation to a new target BS, besides the MRS. In case where a node managed by the target BS is using a basic CID being used by the child node managed by the MRS, a primary management CID, a secondary management CID, and a transport ICD of the child node, it may be required to reassign an ID to the MRS's child node. When assigning the ID to the child node of the MRS, the transparency to the child node is not guaranteed. Therefore, a solution is required to prevent the procedure of reassigning the ID to the child node in the handover of the MRS.

To prevent the reassignment of the ID to the MRS's child node in the handover of the MRS, the CID can be managed separately by each RS. In specific, when the total number of the CIDs is x, the RSs separately manage the x-ary CIDs. Without intervention of the serving BS, the RS assigns the x-ary CIDs to its child node in person. For instance, the CID of the child node 1 managed by the RS A of the CID 2000 is 1000 and the CID of the child node 2 managed by the RS B of the CID 2001 is 1000. Even when the RS A of the CID 2000 executes the handover and is assigned the CID 1000 from the final target node, the CID 1000 of the child node 1 managed by the RS 1 is retained. The CID of the child node may be changed in the handover of the RS's child node, whereas the CID of the child node does not change in the communications with the RS, regardless of the RS's handover.

Alternatively, to prevent the reassignment of the CID to the MRS's child node in the handover of the MRS, the RS can separately manage a CID destined for the RS's child node and a CID destined for the RS's serving BS with respect to the child node ID of the RS. In more detail, the RS assigns the child node a separate CID which is different from the CID assigned to the RS's child node by the serving BS. Data to the child node, which is transmitted with the CID assigned by the serving BS, is delivered to the child node with the CID separately assigned by the RS, instead of the CID assigned by the serving BS. By way of example, when the serving BS assigns the child node the CID 1000, the RS assigns the child node a separate CID 2000. Upon receiving data destined for the child node corresponding to the CID 1000 from the serving BS, the RS sends the received data to the child node by assigning 2000 to the CID of the data. Or, when receiving data destined for the serving BS from the child node assigned the CID 2000, the RS transmits the data to the serving BS by changing the CID of the data of the child node to 1000. Accordingly, even when the RS executes the handover and is assigned the CID 3000 for its child node by the final target BS, the RS transmits the data destined for the child node using the CID 1000. Therefore, even when the CID is changed due to the RS's handover, the CID of the child node is retained.

In this case, when a new CID is assigned to the terminal by the target BS due to the handover of the MRS, the MRS maps and stores a CID assigned by itself (referred as a ‘first CID’) and a CID assigned from the target BS (referred as a ‘second CID’). Hence, after the handover, the MRS can send a message destined for the terminal by converting the second CID of the message to the first CID and send a message from the terminal to the target BS by converting the first CID of the message to the second CID.

Hereinafter, descriptions are provided on the structure of the RS and the BS according to the present invention. Since the RS and the BS having the same interface module (communication module) have a similar structure, operations of the RS and the BS are illustrated using either device to facilitate understanding.

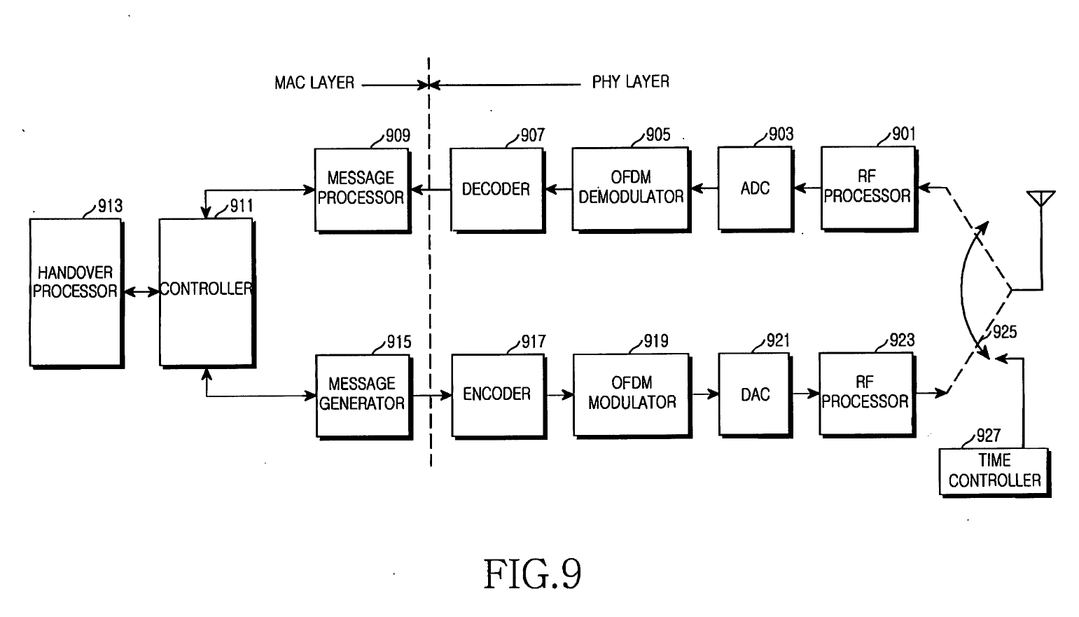

FIG. 9 is a block diagram of a RS or a BS according to the present invention. The following explanation assumes a TDD-OFDM system.

As shown in FIG. 9, the RS or the BS includes a Radio Frequency (RF) processor 901, an ADC 903, an OFDM demodulator 905, a decoder 907, a message processor 909, a controller 911, a handover processor 913, a message generator 915, an encoder 917, an OFDM modulator 919, a DAC 921, an RF processor 923, a switch 925, and a time controller 927.

Referring to FIG. 9, the time controller 927 controls the switching operation of the switch 925 based on frame sync. For instance, in a signal Rx interval, the time controller 927 controls the switch 925 to connect an antenna to the RF processor 901 of the receiving end. In a signal Tx interval, the time controller 927 controls the switch 925 to connect the antenna to the RF processor 923 of the transmitting end.

In the Rx interval, the RF processor 901 converts the RF signal received via the antenna to a baseband analog signal. The ADC 903 converts the analog signal of the RF processor 901 to sample data. The OFDM demodulator 905 outputs frequency domain data by performing fast Fourier transform (FFT) on the sample data output from the ADC 903.

The decoder 907 selects sub-carrier data to be actually received from the frequency domain data of the OFDM demodulator 905, and demodulates and decodes the selected data according to a preset modulation level (MCS level), and outputs the data to the message processor 909 of the MAC layer.

The message processor 909 analyzes the control message from the decoder 907 and provides the analysis result to the controller 911. In the present invention, the message processor 909 extracts various control information from the received handover-related control messages and provides the extracted information to the controller 911.

The controller 911 carries out the corresponding process for the information from the message processor 909 and provides the result to the message generator 915. In the present invention, the handover processor 913 serves to generate and manage information required for the handover under the control of the controller 911.

The message generator 915 generates a message using the information provided from the controller 911 and outputs the generated message to the encoder 917 of the physical layer. In the present invention, the message generator 915 generates a handover-related control message and outputs the generated message to the encoder 917.

The encoder 917 encodes and modulates the data from the message generator 915 according to the preset modulation level (MCS level). The OFDM modulator 919 outputs sample data (OFDM symbols) by performing inverse fast Fourier transform (IFFT) on the data from the encoder 917. The DAC 921 converts the sample data to an analog signal and outputs the analog signal. The RF processor 923 converts the analog signal of the DAC 921 to an RF signal and transmits the RF signal via the antenna.

As constructed above, the controller 911, which is a protocol controller, controls the message processor 909, the message generator 915, and the handover processor 913. In other words, the controller 911 is able to function as the message processor 909, the message generator 915, and the handover processor 913. Herein, the message processor 909, the message generator 915, and the handover processor 913 are separately provided to discriminate their functions for better understanding. Thus, in actual implementation, the controller 911 can be configured to handle all or part of the message processor 909, the message generator 915, and the handover processor 913.

Now, operations of the RS and the BS are illustrated respectively based on the structure of FIG. 9. Particularly, the following explanations center on the control message processing in the MAC layer and the operation of the MRS which executes the handover.

As for the RS, the message processor 909 analyzes the control message received from a terminal, a BS, or another RS and notifies the controller 911 of the analysis result. In the present invention, when the MOB_RSHO-RSP message (see, Table 2), the RSHO-INFORM message (see, Table 8), and the RSHO-notify message (see, Table 10) are received, the message processor 909 extracts various control information from the received messages and provides the extracted information to the controller 911. Next, the controller 911 conducts the corresponding processes according to the control information from the message processor 909. Since the reception of each message has been described in detail, further explanations shall be omitted for brevity.

The handover processor 913 generates information for the communication procedures required for the handover under the control of the controller 911 and provides the generated information to the controller 911. For instance, the handover processor 913 determines whether to execute the handover request, collects adjacent node information suitable for the handover execution, processes the handover information received from the BS, finally determines the handover execution, selects a target node for the handover, determines whether to support the RS capability after the handover to the final target node, and then notifies the controller 911 of the processing results.

The message generator 915 generates a message to transmit to the terminal, the BS, or another RS under the control of the controller 911 and provides the generated message to the physical layer. In the present invention, the message generator 915 generates the MOB_RSHO-REQ message (see, Table 1), the MOB_RSHO-IND message (see, Table 3), and the RSHO-INFORM-ACK message (see, Table 9) and then provides the generated messages to the physical layer. The generation of each message has been illustrated in detail, and thus further explanation shall be omitted for brevity. The message generated at the message generator 915 is processed into a transmittable form at the physical layer and then transmitted through the antenna.

Meanwhile, the controller 911 directly manages a set of CIDs that are assignable to the child node. If a new CID is assigned to the child node by the target BS after the handover, the controller 911 stores a mapping relation of the CID directly assigned to the child node and the new CID. Afterwards, when receiving a message destined for the child node from the target BS, the controller 911 processes a function to convert the CID of the received message to the CID directly assigned according to the mapping relation.

As for the BS, the message processor 909 analyzes control messages received from a terminal, an RS, or another BS and notifies the controller 911 of the analysis results. In the present invention, when the MOB_RSHO-REQ message (see, Table 1), the MOB_RSHO-IND message (see, Table 3), and the RSHO-INFORM-ACK message (see, Table 9) are received from the RS or the HO-request message (see, Table 4), the HO-response message (see, Table 6), and the HO-confirm message (see, Table 7) are received from the another BS, the message processor 909 extracts various control information from the received messages and provides the extracted information to the controller 911. Next, the controller 911 executes the corresponding processes according to the control information fed from the message processor 909. Since the reception of each message has been illustrated in detail, further explanation shall be omitted for brevity.

The handover processor 913 generates information for the communication procedure required for handover under the control of the controller 911 and provides the generated information to the controller 911. For instance, the handover processor 913 recognizes the MRS which requests the handover, acquires the candidate adjacent node list recommended by the MRS, notifies the adjacent cell BS of the MRS's handover request, makes a candidate adjacent node list suitable for the MRS from the adjacent cell BS and the serving cell node, acquires a target node to which the MRS is to be handed over, processes the information of the child node which migrates together with the handed-over MRS, and then provides the processing result to the controller 911.

The message generator 915 generates a message to transmit to the terminal, the RS, or another BS under the control of the controller 911 and provides the generated message to the physical layer. In the present invention, the message generator 915 generates the MOB_RSHO-RSP message (see, Table 2), the RSHO-INFORM message (see, Table 8), and the RSHO-notify message (see, Table 10) to transmit to the RS or the HO-request message (see, Table 4), the HO-response message (see, Table 6), and the HO-confirm message (see, Table 8) to transmit to another BS. Of the generated messages, the message to wirelessly transmit is forwarded to the physical layer, and the message to transmit over the backbone network is forwarded to a backbone interface (not shown). The message generated at the message generator 909 is processed into a transmittable form at the physical layer and then transmitted through the antenna.

As set forth above, when the direct link channel conditions between the BS and the terminal are poor in the BWA communication system using the OFDM/OFDMA scheme, the present invention can provide the terminal with the same services and functions as in the communications using the direct link to the BS by virtue of the RS capable of providing the multihop relay path between the terminal and the BS. Advantageously, the continuous communications can be guaranteed to the MRS and the child node in the service area of the MRS by the suggested MRS handover method in the multihop relay system. Additionally, the MRS can select a suitable target node capable of providing the uninterrupted communication service by utilizing the RS capability information and the child node information of the MRS as the handover control information. Furthermore, even when the RS capability is suspended due to the handover, the uninterrupted service can be provided to the child node of the MRS through the forced handover of the MRS's child node.

Although embodiments of the present invention have been shown and described, it will be appreciated by those skilled in the art that changes may be made in these embodiments without departing from the principles and spirit of the invention, the scope of which is defined in the claims and their equivalents.

What is claimed is:

1. A communication method of a mobile relay station (MRS) in a cellular communication system, the method comprising:
transmitting a handover request message including child node information to a serving base station (BS) when handover is required;
receiving a handover response message including an adjacent node list from the serving BS;
determining a handover target node based on information contained in the handover response message; and
transmitting a handover indication message including the target node to the serving BS.

2. The communication method as in claim 1, further comprising, following transmitting the handover indication message:
performing a required network reentry procedure with the target node.

3. The communication method as in claim 1, further comprising, following transmitting the handover indication message:
performing a network reentry procedure with respect to the child node.

4. The communication method as in claim 1, further comprising:
forcibly handing over the child node when the MRS does not function as the relay station (RS) after the handover to the target node.

5. The communication method as in claim 1, wherein the handover request message contains at least one of an identifier (ID) of the MRS, IDs and signal strength measurement information of adjacent nodes, and the child node information of the MRS.

6. The communication method as in claim 5, wherein the adjacent nodes include at least one of a BS of an adjacent cell, an RS of the adjacent cell, a serving BS, and an RS of a serving cell.

7. The communication method as in claim 1, wherein the handover response message contains at least one of RS capability information and a service level provided after the handover, and the ID of the MRS.

8. The communication method as in claim 1, wherein the handover indication message contains at least one of the ID of the MRS, an ID of the target node, and the child node information of the MRS.

9. The communication method as in claim 1, wherein the target node is determined by taking into account at least one of a signal strength acquired through scanning, an RS capability after the handover, a service level provided after the handover, and a bandwidth provided after the handover.

10. The communication method as in claim 1, wherein the MRS manages a set of connection IDs (CIDs) to be directly assigned to a child node.

11. The communication method as in claim 10, further comprising:
sending, when receiving a message destined for a child node from the serving BS, the message to the child node by converting a CID of the received message to a CID directly assigned to the child node by the MRS.

12. The communication method as in claim 10, further comprising:
storing a mapping relation of the CID directly assigned to the child node and a new CID when the new CID is assigned to the child node of the MRS by a target BS after the handover to the target node; and
sending, when a message destined for the child node is received from the target BS, the message to the child node by converting a CID of the received message to a CID directly assigned according to the mapping relation.

13. The communication method as in claim 10, wherein a CID directly assigned to the child node by the MRS is retained after the handover.

14. A communication method of an MRS in a cellular communication system, the method comprising:
receiving a handover response message containing an adjacent node list from a serving BS when handover is required;
determining a handover target node based on information contained in the handover response message; and
transmitting a handover indication message including the target node.

15. The communication method as in claim 14, wherein the handover response message contains at least one of IDs of adjacent nodes, RS capability information and service level provided after handover, and an ID of the MRS.

16. The communication method as in claim 14, wherein the handover indication message contains at least one of the ID of the MRS, an ID of the target node, and child node information of the MRS.

17. The communication method as in claim 14, wherein the MRS manages a set of CIDs to be directly assigned to a child node.

18. The communication method as in claim 14, wherein a CID directly assigned to the child node by the MRS is retained after the handover.

19. A communication method of a serving BS in a cellular communication system, the method comprising:
receiving a handover request message containing child node information from an MRS when handover of the MRS is required;
making an adjacent node list by collecting handover-related information from adjacent nodes to which the MRS is able to be handed over when the handover request message is received;
transmitting a handover response message including the adjacent node list to the MRS; and
receiving a handover indication message including a handover target node from the MRS.

20. The communication method as in claim 19, wherein the handover response message is transmitted to the MRS when the serving BS initiates the handover or when a handover request message is received from the MRS.

21. The communication method as in claim 19, further comprising:
performing a required network re-entry procedure with the MRS when the target node set in the handover indication message is the serving BS;
transmitting a handover notification message to the target node when the target node is a serving cell node; and
releasing connection resources from the MRS after transmitting a handover confirm message to an adjacent cell BS when the target node is an adjacent cell node.

22. The communication method as in claim 20, wherein the handover request message contains at least one of IDs and signal strength measurement information of the adjacent nodes, and the child node information of the MRS.

23. The communication method as in claim 22, wherein the adjacent nodes include at least one of a BS of an adjacent cell, an RS of the adjacent cell, a serving BS, and an RS of a serving cell.

24. The communication method as in claim 19, wherein the handover response message contains at least one of IDs of the adjacent nodes, RS capability information and service level provided after handover, and an ID of the MRS.

25. The communication method as in claim 19, wherein the handover indication message contains at least one of the ID of an MRS, an ID of the target node, and the child node information of the MRS.

26. The communication method as in claim 19, wherein making the adjacent node list comprises:
transmitting a handover inform message which informs adjacent nodes to which the MRS is able to be handed over of handover feasibility;
receiving a response message containing handover-related information from the adjacent nodes; and
making the adjacent node list using the handover-related information collected from the adjacent nodes.

27. The communication method as in claim 26, wherein the adjacent nodes to which the MRS is able to be handed over include at least one of a BS of an adjacent cell an RS of the adjacent cell, a serving BS, and an RS of a serving cell.

28. The communication method as in claim 26, wherein the handover inform message contains at least one of an ID of the MRS, capability information of the MRS, the child node information of the MRS, a required bandwidth, and a required service level.

29. The communication method as in claim 26, wherein the response message contains at least one of an ID of the MRS, capability information of the MRS after the handover, a bandwidth and a service level provided to the MRS.

30. An MRS apparatus in a cellular communication system, comprising:
a message generator which generates a handover request message containing child node information when handover is required;
a transmitter which converts the message generated at the message generator according to a prescribed wireless standard and sends the converted message via an antenna;
a message processor which extracts an adjacent node list from a handover response message received from a serving BS after the handover request message is transmitted; and
a handover processor which determines a handover target node based on the adjacent node list.

31. The MRS apparatus as in claim 30, wherein the message generator generates and provides a handover indication message containing the target node to the transmitter.

32. The MRS apparatus as in claim 30, wherein the handover request message contains at least one of an ID of the MRS, IDs and signal strength measurement information of adjacent nodes, and child node information of the MRS.

33. The MRS apparatus as in claim 32, wherein the adjacent nodes include at least one of a BS of an adjacent cell, an RS of the adjacent cell, a serving BS, and an RS of a serving cell.

34. The MRS apparatus as in claim 30, wherein the handover response message contains at least one of IDs of the adjacent nodes, RS capability information and service level provided after handover, and an ID of the MRS.

35. The MRS apparatus as in claim 31, wherein the handover indication message contains at least one of an ID of the MRS, an ID of the target node, and child node information of the MRS.

36. The MRS apparatus as in claim 30, wherein the handover processor forcibly hands over a child node of an RS when the MRS does not function as the RS after the handover.

37. The MRS apparatus as in claim 36, wherein the handover processor performs a required network reentry procedure with the target node after determining the handover to the target node.

38. The MRS apparatus as in claim 36, wherein the handover processor performs network re-entry procedures for the child node after determining the handover to the target node.

39. The MRS apparatus as in claim 30, wherein the target node is determined by taking into account at least one of a signal strength acquired through scanning, RS capability after the handover, a service level provided after the handover, and a bandwidth provided after the handover.

40. The MRS apparatus as in claim 30, further comprising:
a controller which manages a set of CIDs to be directly assigned to a child node.

41. The MRS apparatus as in claim 40, wherein the controller a CID directly assigned to the child node is retained after the handover.

42. A BS apparatus in a cellular communication system, comprising:
a handover processor which makes an adjacent node list by collecting handover-related information from adjacent nodes to which the MRS is able to be handed over when handover of the MRS is required;
a message generator which generates a handover response message containing the adjacent node list; and
a transmitter which processes the message generated at the message generator according to a prescribed wireless standard and transmits the processed message via an antenna.

43. The BS apparatus as in claim 42, wherein the handover response message is transmitted to the MRS when the BS initiates the handover or when a handover request message is received from the MRS.

44. The BS apparatus as in claim 42, further comprising:
a message processor which extracts target node information from a handover indication message received from the MRS after the handover response message is transmitted.

45. The BS apparatus as in claim 44, wherein the message generator generates and provides a handover inform message to be transmitted to the target node to the transmitter when the target node is a serving cell node.

46. The BS apparatus as in claim 44, wherein the message generator generates a handover confirm message to be transmitted to a BS of an adjacent cell when the target node is an adjacent cell node.

47. The BS apparatus as in claim 43, wherein the handover request message contains at least one of an ID of the MRS, IDs and signal strength measurement information of the adjacent nodes, and the child node information of the MRS.

48. The BS apparatus as in claim 42, wherein the handover response message contains at least one of IDs of the adjacent nodes, RS capability information and a service level provided after the handover, and an ID of the MRS.

49. The BS apparatus as in claim 44, wherein the handover indication message contains at least one of an ID of the MRS, an I) of the target node, and the child node information of the MRS.

50. The BS apparatus as in claim 42, wherein the handover processor sends a handover inform message, which informs handover feasibility, to adjacent nodes to which the MRS is able to be handed over, and makes the adjacent node list using handover-related information of response messages received from the adjacent nodes.

51. The BS apparatus as in claim 50, wherein the adjacent nodes to which the MRS is able to be handed over include at least one of a BS of an adjacent cell, an RS of the adjacent cell, a serving BS, and an RS of a serving cell.

52. The BS apparatus as in claim 50, wherein the handover inform message contains at least one of an ID of the MRS, capability information of the MRS, the child node information of the MRS, a required bandwidth, and a required service level.

53. The BS apparatus as in claim 50, wherein the response message contains at least one of an ID of the MRS, capability information of the MRS after the handover, a bandwidth and a service level provided to the MRS.

54. A handover processing method of an MRS in a cellular communication system, the method comprising:
transmitting, by the MRS, a handover request message containing child node information to a serving BS when handover is required;
making, by the serving BS, an adjacent node list by collecting handover-related information from adjacent nodes to which the MRS is able to be handed over when the handover request message is received;
transmitting, by the serving BS, a handover response message containing the adjacent node list to the MRS; and
determining, by the MRS, a handover target node based on information contained in the handover response message and transmitting a handover indication message containing the target node to the serving BS.

55. The handover processing method as in claim 54, wherein the handover request message contains at least one of an ID of the MRS, IDs and signal strength measurement information of the adjacent nodes, and the child node information of the MRS.

56. The handover processing method as in claim 54, wherein the handover response message contains at least one of IDs of the adjacent nodes, RS capability information and a service level provided after the handover, and an ID of the MRS.

57. The handover processing method as in claim 54, wherein the handover indication message contains at least one of an ID of the MRS, an ID of the target node, and the child node information of the MRS.

58. The handover processing method as in claim 54, wherein making the adjacent node list comprises:
transmitting, by the serving BS, a handover inform message informing of handover feasibility to the adjacent nodes;
transmitting, by the adjacent nodes, a response message containing handover-related information to the serving BS; and
making, by the serving BS, the adjacent node list using the handover-related information collected from the adjacent nodes.

59. The handover processing method as in claim 54, further comprising, following transmitting the handover indication message:
performing, by the MRS, a required network reentry procedure with the target node.

60. The handover processing method as in claim 54, further comprising, following transmitting the handover indication message:
performing, by the MRS, a network re-entry procedure for the child node.

61. The handover processing method as in claim 54, further comprising:
forcibly handing over, by the MRS, the child node when the MRS does not function as an RS after the handover to the target node.

62. The handover processing method as in claim 58, wherein the handover inform message contains at least one of an ID of the MRS, capability information of the MRS, the child node information of the MRS, a required bandwidth, and a required service level.

63. The handover processing method as in claim 58, wherein the response message contains at least one of an ID of the MRS, capability information of the MRS after the handover, a bandwidth and a service level provided to the MRS.
